(19) United States
(12) Patent Application Publication
(10) Pub. No.: US 2018/0312449 A1
(43) Pub. Date: Nov. 1, 2018

(54) A GRANULAR FERTILIZER OR SOIL CONDITIONER AND ITS USE

(71) Applicants: Jari JÄRVINEN, Kouvola (FI); Pasi J. VIRTANEN, Lappeenranta (FI); Kati MUSTONEN, Lappeenranta (FI)

(72) Inventors: Jari JÄRVINEN, Kouvola (FI); Pasi J. VIRTANEN, Lappeenranta (FI); Kati MUSTONEN, Lappeenranta (FI)

(21) Appl. No.: 15/769,906

(22) PCT Filed: Oct. 20, 2016
(86) PCT No.: PCT/EP2016/075224

§ 371 Date: Apr. 20, 2018

(30) Foreign Application Priority Data
Oct. 23, 2015 (FI) 20155758

(51) Int. Cl. C05G 3/00; C05F 9/00; C05F 5/00; C05C 9/00; C05C 1/02; C05C 3/00; C05G 3/04

(52) U.S. Cl. CPC C05G 3/0041; C05F 9/00; C05F 5/004; C05G 3/04; C05C 1/02; C05C 3/005; C05C 9/00

(57) ABSTRACT

A granular fertilizer or soil conditioner containing at least three layers, a layer (12) having a core media and at least one nitrogen compound, an alkaline layer (16) and an inert barrier layer (14) there between. The fertilizer may be used to replace commercially available chemical or mineral fertilizers.

### TECHNICAL FIELD

The present invention relates to a granular fertilizer or soil conditioner and its use. The present invention relates specifically to a granular fertilizer or soil conditioner having a layered structure comprising at least three layers, a layer having at least one nitrogen compound, an alkaline layer, and an inert barrier layer therebetween. The fertilizer or soil conditioner of the present invention may be used to replace commercially available soil conditioners or chemical or mineral fertilizers.

### BACKGROUND ART

A feature common to all domestic, agricultural, municipal and industrial activities is that they create waste and side flows. The waste and side flows contain both organic and inorganic fractions. Historical prior art method of handling waste and side flows, irrespective of their content or origin, has been to dump such with as little effort as possible. Even nowadays that dumping is, in principle, not allowed the main goal is just to get rid of the waste or side flows with as low expenses as possible. Thus, for preventing harmful substances from getting into the ground waste incineration has been used. Waste incineration is very often performed at a very low efficiency and, moreover, in such a way that combustion gases are allowed to be discharged into the atmosphere in a way that increases environmental load in the form of either only carbon dioxide or possibly many other compounds, in some cases even in the form of toxic or almost toxic compounds. Incineration of the waste leads also to, in practice, final loss of nutrients, as combusting the waste or side flows normally means that, for instance, the nitrogen, vital for the growth of plants, is lost in the form of less desirable NOx emissions, and the phosphorus from the flows remains in the ash that contains heavy metals very often to such an extent that the ash cannot be used but only as landfill in such a manner that plants cannot utilize the phosphorus any more. As to nutrients in general, nitrogen is the most challenging one in view of chemical bonding of bio-based nitrogen. Nitrogen is, by nature, very inert, whereby reactions involving nitrogen require either energy or appropriate chemicals.

In recent years both the strengthening legislation and environmental awareness has led to more and more efficient ways of handling both domestic, agricultural, municipal and industrial waste and side flows such that organic and inorganic fractions are separated and used separately. The organic fraction may be either composted or processed into bioethanol via fermentation or processed into biogas such as methane by means of anaerobic treatment. There is a high need for bio carbon in modern fertilizing agriculture world, too. The list of possible advanced processes for treating organic waste is ever growing. The inorganic fraction—very often combusted ash—also has several application e.g. in the fields of road construction and construction material industry. The ash may be used as land fill material, for noise barriers, and for foundation and covering of landfill sites, just to name a few alternative uses. The use of inorganic ash as fertilizer or soil conditioner has also a long history dating back to the beginning of agriculture.

For instance, in some advanced cases, a certain waste or side flow is taken, for example, to a bio ethanol plant, where specifically bio ethanol is sought to be recovered from the waste, the rest of the end product ending up as waste, i.e. to be either incinerated, handled in connection with waste water processes or dumped as landfill. In some cases also the residual matter from the primary use finds some other application. For example, if the raw material is clean bakery waste, the residual from an ethanol plant may be further used as livestock fodder. However, if the raw material is containing even slightly less pure ethanol raw material, the residual from ethanol production processes has been traditionally taken as waste slurry to municipal waste processing.

In recent years a number of patent documents have come up discussing a more comprehensive approach for processing organic waste material. As an example of those documents WO-A1-2014044945 may be mentioned, the disclosure of which is fully incorporated herein by reference.

The document teaches how the waste and side flows of pulp and paper industry may be taken in efficient use such that, depending on the waste and side flow fractions and processes used, the entire process may result in the production of ethanol, bio gas, construction material and fertilizer. There are, in general, two types of waste and side flows of pulp and paper industry.

The first type is wood and bark based waste flow, mainly originating from the wood yard, that is incinerated as a so called hog fuel in a bark boiler to generate heat and/or electricity and ash. The ash, however, contains heavy metals, but it may be treated by dividing the ash into a coarse ash fraction, which is, by nature, lean in heavy metals, and a fine ash fraction rich in heavy metals. The coarse ash fraction may be taken to fertilizer production and the fine ash fraction, for instance, to construction material industry to replace part of the cement in concrete production.

Another type of waste and side flows are fibrous slurries. The fibrous slurry recovered as filtrates from various processes at a pulp and/or paper mill is taken to a separation stage where the fibrous slurry is divided into a first effluent and a first slurry. The first effluent is taken to a biological waste water treatment plant, from which a clear effluent is discharged to a river, a lake or a sea, and the bio slurry in the bio refinery. The first slurry is further fractionated into one or more coarse fractions and a fine fraction. The fine fraction containing mainly organic matter is taken to the bio refinery, and the coarse fraction/s may be dumped as land fill or used, for instance in fertilizer production. The bio refinery has a fermentation reactor for producing ethanol and/or an anaerobic digester for producing biogas. The residual slurry discharged from the bio refinery is called a digestate. The bio refinery may, optionally, be provided with algae pond for providing more organic matter in the digestate. The biogas collected from anaerobic digestion contains nitrogen, which is stripped from the biogas originating from the anaerobic digestion process as a nitrogen compound, like ammonium sulfate (AS). Stripping means a simple process where ammonia from the bio gas is scrubbed, for instance, with sulphuric acid and recovered as a 40% TS (total solids, dry matter) ammonium sulphate solution.

The above cited WO-reference teaches further that the coarse ash fraction lean in heavy metals and the nitrous compound are taken to fertilizer production to be mixed together with the digestate that is dewatered to increase its dry matter content. Optionally also a coarse fraction collected from the fractionating stage of the first slurry may be used in fertilizer production.

However, the above WO-document, though it explains how the waste and side flows of pulp and paper industry may be taken in full use, does not tell, for instance, how the actual recovery of nitrogen is performed. The WO-document does not pay any attention to the fact that in waste sludges having a neutral pH the nitrogen is often present in the form of ammonium ion, which is highly water soluble, but if the pH is increased for whatever reason the ammonium ions start converting into volatile ammonia. The WO-document only tells that nitrogen may be stripped from the biogas and that nitrogen is also present in the digestate of the anaerobic digestion process, but the actual production of the fertilizer is not described.

Another problem relating to the use of fertilizers or soil conditioners concerns the actual production of the fertilizer or soil conditioner such that the fertilizer or soil conditioner is capable of being stored for months and spread on the field by means of present equipment. In other words, the present equipment, which are designed for spreading commercially available chemical or mineral fertilizers, require that the fertilizer is in the form of granules having maximum dimension of less than 8 mm and that the fertilizer granules are strong enough to withstand the forces a centrifugal spreader subjects to them. The fertilizer granules have to endure also long-lasting compressive stresses when they are stored, for instance, in sacks or bags in piles containing tens of sacks/bags. Also, the granules should be able to withstand moisture, as, though stored in sacks or large bags containing up to 1000 kg fertilizer, there is always some moisture in the air in the sacks or bags and, sometimes, small holes may be punched in the sacks or bags so that additional moist air may get into the sacks or bags.

As to soil conditioners, for instance, there are no such soil conditioners available today that could be spread using centrifugally operating spreaders as the soil conditioners are in the form of powder. Also, long-lasting (over winter) storage of present day soil conditioners is impossible due to their tendency of collecting moisture, and, as a result, either hardening or starting to grow micro-organisms.

In addition to the above granule-related problems, the recovery of nitrogen and the use of recovered nitrogen compounds have a number of other problems.

Firstly, the nitrogen, as well as phosphorus and many other nutrients, like potassium, calcium, etc., too, are present in the waste and side flows in various forms. For instance, the nitrogen is typically bound in proteins. On top of organic phosphorus it may be bound in ferro- or similar flocculating compounds that is the case especially if using municipal sludges. The nutrients may also be in water soluble form (phosphate, nitrate, ammonium, organic nitrogen) and also in a volatile form (ammonia). All the above three forms are present, for instance, in the effluent of anaerobic digestion, i.e. digestate. In other words, when treating the digestate by removing liquid therefrom a considerable part of the nitrogen is removed in the filtrate. Also, for instance, if the pH of the digestate and/or the filtrate is raised, or allowed to raise, to above 7, i.e. to about 7.5 . . . 8 or above, the nitrogen compound starts to evaporate as the ammonium starts converting to ammonia. Thus, the nitrogen has to be recovered from the filtrates and the pH in the process has, at least, to be kept below 8. The nitrogen may be recovered by stripping from gases or by treating filtrates with some other appropriate manner. Other macro nutrients, like phosphorus, potassium etc. as well as micro nutrients, like iron, selenium, boron, etc. are present in the waste and side flows, too, and if combusted they enrich in the ash fraction.

Secondly, the same pH-related problem may be seen in the production of the fertilizer, as, if the pH is allowed to be raised in the production process or somewhere in the storage phase above about 7.5 . . . 8 in the immediate nearhood of the ammonium (NH₄⁺), volatile ammonia (NH₃) starts forming and the nitrogen content of the fertilizer is reduced equally with the effect on growth of the plants. Additionally, the evaporation of the nitrogen compound means that toxic ammonia is released in air, whereby health-related issues are also at hand.

Thirdly, when considering the use of bio-based matter recovered from domestic, municipal, agricultural and industrial waste and side flows the generally preferred properties of fertilizers or soil conditioners have to be taken into account. Such preferred properties are:
the fertilizer has to include sufficient amount of one or more vital nutrients, like nitrogen, phosphorus, potassium etc., i.e. (NPK+others),
the fertilizer (especially, modern organic fertilizer) has to include bio carbon,
the fertilizer or soil conditioner has to have physical properties such as hardness, size and moisture control to withstand storage conditions (pressure, moisture), as well as field distribution with modern machines and controlled delivery of nutrients to plants,
the fertilizer or soil conditioner has to have chemical properties to withstand microbial activity such as mold, and
the granular fertilizer or soil conditioner should have buffering properties to prevent soil acidification.

### BRIEF SUMMARY OF THE INVENTION

In view of the above, an object of the present invention is to develop such a novel granular fertilizer or soil conditioner that the evaporation of a nitrogen compound as volatile ammonia is prevented.

Another object of the present invention is to develop such a novel granular fertilizer or soil conditioner that is capable of preventing the pH in the nearhood of the nitrogen compound from raising to a value causing the conversion of ammonium (NH₄⁺) to ammonia (NH₃).

A yet another object of the present invention is to develop a novel granular fertilizer or soil conditioner where both recovered nitrogen compounds and various commercially available nutrients may be used.

A further object of the present invention is to develop a novel granular fertilizer or soil conditioner, where, in addition to nitrogen compound/s used as fertilizer, also ash may be used as a soil conditioner.

A yet further object of the present invention is to develop a novel granular fertilizer or soil conditioner that may also be used as a soil conditioner whereby in addition to the use of nitrogen as the fertilizer the granule may contain soil conditioners in the form of one or more of burned lime (CaO), calcium carbonate (CaCO₃), and ash each having a high pH value.

A still further object of the present invention is to develop a novel granular fertilizer or soil conditioner that has buffering properties to prevent soil acidification.

One further object of the present invention is to develop a novel granular fertilizer or soil conditioner that is provided with a hard shell made of hardening components (like for instance ash, burned lime (CaO), calcium carbonate (CaCO₃), magnesium oxide (MgO), sugar slurry, bio plastics, geopolymers) for enabling the modern operations with centrifugal fertilizer spreading machines.

At least some of the above and other objects of the present invention are met with a granular fertilizer or soil conditioner having a layered structure comprising at least three layers, a layer having at least one nitrogen compound, an alkaline layer, and an inert barrier layer therebetween.

Other characteristic features of the present invention become evident from the appended dependent claims and the following description of the various embodiments of the present invention.

By applying the present invention at least some of the following advantages are gained:
instead of incinerating the waste and side flows, utilizing the flows efficiently,
binding of nitrogen, phosphorus and other recoverable nutrients to fertilizer,
not requiring chemical processing,
preventing soil depletion by recovering, among others, phosphorus into a biofertilizer, which reduces the need for chemical fertilizers,
making nutrient cycle more effective (for example, one is able to recover more phosphorus for reuse),
reducing the amount of waste for final disposal,
replacing the line (CaO) with ash as soil conditioner,
spreading both the fertilizer and the soil conditioner simultaneously reduces work at farms and the compaction of the soil and
taking into use one or more alkaline components that adjust the pH of the soil thus preventing its acidification. Such is needed as agricultural soil is mostly acidic by nature and acidic rain fall is further decreasing the soil pH.

### DEFINITIONS

Bio carbon carbon originating from bio-based organic raw materials.

Bio-based matter organic matter recovered directly or indirectly from domestic, agricultural, municipal and industrial waste and side flows. May be derived from animal, human or vegetable matter (e.g. compost, manure). Includes, for instance, restaurant, bakery, slaughterhouse, fishery and dairy wastes, digestate from biogas process, mash from various alcohol (whisky, beer, ethanol) production processes, sludges from various waste water treatment plants (like those of, for instance, mechanical wood processing, pulp, paper or sugar production plants), composted organic waste material, etc.

Biofertilizers fertilizers comprising bio-based matrix.

Digestate bio-based matter recovered from aerobic or anaerobic biogas process

Fertilizer used for improving growth of plants. Fertilizers may be divided in chemical, mineral and biomass-based or non-organic and organic fertilizers.

Geopolymers Geopolymers may be classified to pure inorganic geopolymers and organic-containing geopolymers. A geopolymer is essentially a mineral chemical compound or mixture of compounds consisting of repeating units, for example silico-oxide (—Si—O—Si—O—), silico-aluminate (—Si—O—Al—O—), ferro-silico-aluminate (—Fe—O—Si—O—Al—O—) or alumino-phosphate (—Al—O—P—O—), created through a process of geopolymerization. They find use in road construction, building materials, fire resistant composite materials in aircrafts and other vehicles, etc.

Inert understood as such a compound or matter that does not have harmful effects on the nutrient/s, i.e. the nutrients when being in contact with an inert matter or compound do not lose their nutrient value. Inert matter may, thus, be, either virgin or recycled matter, like, just to name a few examples, a ground mineral, a compound having a favorable pH, recycled side flow, recycled rejectable fiber material, mineral fraction of DIP (deinked pulp) process, etc

MAP Magnesium Ammonium Phosphate, so called kidney stone or bladder stone, not literally nutrient recovered by stripping, but chemically produced nutrient.

Macronutrient chemical elements that are essential for the growth of plants like nitrogen, phosphorus, potassium.

Micronutrient chemical elements that plants require in small amount for their growth, e.g. boron, chlorine, calcium, magnesium, sulphur, manganese, iron, zinc, copper, cobalt, molybdenum, nickel, silicon, selenium and sodium.

Mineral fertilizer natural minerals extracted from mines and processed.

Nutrient water soluble applicable compounds of chemical elements required by plants for their growth. Divided in macronutrients and micro nutrients.

Organic fertilizer biomass-based fertilizers fulfilling the legislative requirements set for organic fertilizers. For instance, in Finland, today, both the nitrogen and ash used in the production of the fertilizer may not be brought from elsewhere but has to be recovered from the plant itself.

Self-hardening a property of a pulverous material, like for instance ash, that when sprayed with water, more generally liquid, stops dusting and, due to chemical reactions, starts hardening and (usually) forming some kind of granules.

Side flow such a material flow from, for instance, an industrial facility that the industrial facility cannot any more use in its own processes but that may be taken forward to be utilized by another user.

Soil conditioner a product which is added to soil to improve the soil's physical qualities, especially its ability to provide nutrition for plants. Soil conditioners can be used to improve poor soils, or to rebuild soils which have been damaged by improper management. They can make poor soils more usable, and can be used to maintain soils in peak condition. Lime, ash, carbonate etc. are the most widely used soil conditioners.

Stripping method of recovering chemical compounds from a stream of gas by scrubbing. Here used for recovering chemical compounds (mainly nitrogen in the form of ammonia) from gaseous fractions from waste and side flows (for instance, anaerobic or aerobic digestion).

Waste flow a flow from an industrial facility that neither the industrial facility itself nor any other facility is able to utilize, i.e. a traditionally worthless flow. For instance, bio sludges/slurries and primary sludges/slurries from a pulp and/or paper mill or sugar production plant.

### BRIEF DESCRIPTION OF DRAWING

In the following, the granular fertilizer or soil conditioner of the present invention and the method of manufacturing thereof is discussed in more detail by referring to the appended drawings, of which

FIG. 1 illustrates schematically the equilibrium between ammonium and ammonia as a function of pH,

FIG. 2 illustrates schematically a granular fertilizer or soil conditioner in accordance with a first preferred embodiment of the present invention,

FIG. 3 illustrates schematically the production process of the granular fertilizer or soil conditioner in accordance with the preferred embodiment

FIG. 4 illustrates schematically a granular fertilizer or soil conditioner in accordance with a second preferred embodiment of the present invention, and

FIG. 5 illustrates schematically a granular fertilizer or soil conditioner in accordance with a third preferred embodiment of the present invention.

### DETAILED DESCRIPTION OF DRAWINGS

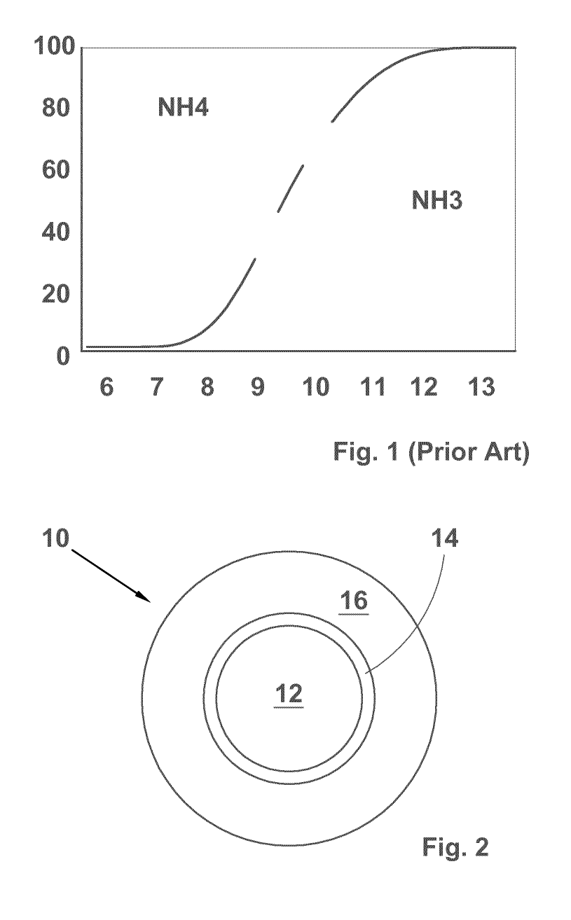

FIG. 1 discusses schematically the basics of the present invention. The graph shows the ammonium/ammonia equilibrium. In practice FIG. 1 shows that when the pH of a liquid, suspension or slurry is low (below about 7) there is no ammonia present, and at a high pH (above about 12) there is no ammonium present. Between pH values 7 and 12 there is both ammonium (NH₄⁺) and ammonia (NH₃) present. What this means, in practice, for instance, is that if the pH− value of a liquid, suspension or slurry is raised or allowed to raise to a value above 7 . . . 7,5 . . . 8 (somewhat depending on the temperature of the liquid, suspension or slurry) the ammonium in the matter starts converting to ammonia, which is, in normal temperature, a volatile compound that evaporates into the atmosphere. When doing so the nitrogen content in the liquid, suspension or slurry decreases and ammonia-related problems (odor) in the air increase.

FIG. 2 discusses schematically a granular fertilizer or soil conditioner in accordance with a first preferred embodiment of the present invention. The fertilizer or soil conditioner granule 10 of FIG. 2 comprises a core granule 12 (in broader terms, a first layer), an inert coating 14 (in broader terms, an inert second or barrier layer) and a shell 16 (in broader terms, a third layer). The core granule 12 is formed of a core media and at least one nitrogen compound mixed therewith. Optionally, the core media may include at least one nitrogen compound. As an example of a number of different core medias to which one or more nitrogen compounds is, depending on the nitrogen source, either mixed or absorbed, i.e. not bonded chemically but physically, may, preferably, be mentioned an inert medium like kaolin as the pH of kaolin is of the order of 7 or less, it has a large specific surface area, it is a natural mineral found also in farm lands, and it endures well chemicals like acids and bases as well as temperature. Additionally, kaolin may be mixed with not only nitrogen-containing compounds but also with other nutrients, like one or more of phosphorus, potassium, calcium, magnesium, sulphur, boron, chlorine, manganese, iron, zinc, copper, cobalt, molybdenum, nickel, silicon, selenium and sodium, or with other components (like soil conditioners or carbon, preferably bio carbon) of a fertilizer or soil conditioner mixture, as will be discussed later on, without chemical side reactions. There is also a number of other applicable inert core media to be used in place of or in combination with kaolin, like for instance talcum, bentonite, silica, silicate, sugar slurry, polylactic acid (PLA), bio plastics, neutral or acidic geo polymers or any combination thereof etc. Furthermore, the core media may consist of or at least comprise bio-based matter, i.e. matter recovered from domestic, agricultural, municipal and/or industrial waste and side flows. The bio-based matter is preferably thickened or otherwise treated to a dry matter content of about 70 to 80% or above.

The nitrogen source may be a process where nitrogen is recovered in the form of a water soluble compound, like for instance, ammonium sulfate (AS), ammonium nitrate (AN), ammonium lactate, magnesium ammonium phosphate (MAP), calcium nitrate (CN), calcium ammonium nitrate (CAN), and urea, just to name a few applicable alternatives without any intention to limit the invention to the listed compounds. CN, MAP and CAN may be mentioned as examples of nitrogen compounds that are, firstly, quickly dissolving compounds, i.e. if introduced in the outer layer of the granular fertilizer or soil conditioner their quick dissolution to the soil gives the plants a quick boosting effect immediately after the spreading of the fertilizer or soil conditioner, and secondly, they are not sensitive to pH and may thus be used in an alkaline environment without the risk of creating volatile ammonia. Of the above discussed nitrogen compounds sensitive to pH are, thus, ammonium sulfate (AS), ammonium nitrate (AN), ammonium lactate and urea. Other nitrogen compounds sensitive to pH are ammonium acetate, ammonium adipate, ammonium aluminium sulfate, ammonium benzoate, ammonium bicarbonate, ammonium bisulfate, ammonium carbamate, ammonium carbonate, ammonium diethyl dithiophosphate, ammonium dihydrogen phosphate, ammonium ferric citrate, ammonium formate, ammonium hydrosulfide, ammonium iron(II) sulfate, ammonium iron(III) sulfate, ammonium lactate, ammonium lauryl sulfate, ammonium malate, ammonium nitrite, ammonium nonanoate, ammonium oxalate, ammonium phosphate, ammonium polyphosphate, ammonium sulfamate, ammonium sulfide, ammonium sulfite, ethylammonium nitrate, ferric ammonium oxalate, monoethanolamine oleate and ammonium thiosulfate.

As an example of sources of bio-based nitrogen an anaerobic biogas production process may be mentioned where digestate is formed as a side product, and nitrogen compounds, as well as other nutrients, may be separated from both the biogas and the filtrate of the digestate. The biogas collected from anaerobic digestion contains, among other compounds, nitrogen compound/s, which is/are stripped from the biogas as nitrogen compound/s, like for instance ammonium sulfate (AS), ammonium nitrate (AN), ammonium lactate and other nitrogen compounds generally used in fertilizer production depending on the acid used for stripping. For instance, in order to be qualified as an organic fertilizer it is required that the nitrogen compound used in the production of the fertilizer is based on ammonia stripped by using an organic acid, like for instance lactic acid. Stripping means a simple process where ammonia from the bio gas is scrubbed, for instance, with sulphuric, nitric or lactic acid and recovered as a 40% TS (total solids, dry matter) ammonium sulphate, nitrate or lactate solution, from which the ammonium sulphate, nitrate or lactate may further be separated as dry crystals by evaporating the liquid away. The recovered ammonium compound may be utilized as a fertilizer and/or in the production of soil conditioner/s. Nitrogen may also be precipitated from sludge, digestate or combination thereof as, for instance, magnesium ammonium phosphate (MAP) by introducing magnesium ions to the mixture in elevated pH conditions. The above mentioned nitrogen compounds AN, AS and MAP may be precipitated as dry crystals, and thus may be utilized as a pulverous dry matter. Calcium ammonium nitrate (CAN) is one optional nitrogen compound having multiple different, but closely related formulations. An optional version is made by adding powdered limestone to ammonium nitrate. Another, fully water-soluble version, is a mixture of calcium nitrate and ammonium nitrate, which crystallizes as a hydrated double salt.

As another source of bio-based nitrogen various filtrates may be mentioned, like for instance filtrates recovered from domestic, agricultural, municipal and industrial waste and side flows. Optionally, such filtrates may be recovered from at least one of domestic, agricultural, municipal and industrial waste and side flows. In other words, bio-based nitrogen may be derived from animal, human or vegetable matter (e.g. compost, manure). Such includes, thus, also restaurant, bakery, slaughterhouse, fishery and dairy wastes, digestate from biogas process, mash from various alcohol (whisky, beer, ethanol) production processes, sludges from various waste water treatment plants (like those of, for instance, mechanical wood processing, pulp, paper or sugar production plants), etc. Such filtrates may be evaporated and the nitrogen may be stripped from the evaporated vapor.

Another source of nitrogen are commercially available chemically manufactured compounds, like ammonium sulfate, ammonium nitrate, magnesium ammonium phosphate, calcium nitrate, calcium ammonium nitrate, and urea.

The inert coating, or the inert second or barrier layer, 14 is, preferably but not necessarily at least one of the same material as the core media of the core granule 12, i.e. kaolin, talcum, bentonite, silica, silicate, etc. The core granule may also be coated, in addition to, or in place of, kaolin or the other listed coating material, with one or more of organic compounds such as sugar slurry, polylactic acid (PLA) or bio plastics, or inorganic compounds such as geopolymers having acidic or neutral pH. Bio-based matter may also be one of the possible alternatives for the barrier layer, as the pH of the bio-based matter is of the order of 7, and very often the natural nitrogen content of the bio-based matter is very low. Also, as the dry matter content of the bio-based matter is relatively high and the matter is porous the bio-based matter efficiently separates the sensitive nitrogen compounds possibly provided in the core granule from the outside of the coating 14. The purpose of the coating 14 is to prevent the ammonium compounds of the core granule 12 from getting into contact with any such outside material that could initiate the conversion of ammonium to volatile ammonia or otherwise make the nitrogen inoperable for fertilizing purposes. Another purpose of the coating is to protect the core granule from getting crushed when storing the fertilizer or soil conditioner in sacks or bags stacked one on top of another or when spreading the fertilizer or soil conditioner on the field. The inert coating may, however, contain such nutrients (including also such nitrogen containing compounds, for instance CN, CAN or MAP, that are not sensitive to pH) and/or soil conditioners and/or carbon, preferably bio carbon, that are not sensitive to high pH, outside moisture etc. In other words, the coating material itself may be mixed with such nutrients and/or soil conditioners and/or carbon, preferably bio carbon, upstream of the coating process or such nutrients and/or soil conditioners and/or carbon, preferably bio carbon, may be added to the coating during the coating process. Thus, the coating material is considered inert when it is made to match the type of nitrogen used such that the nitrogen compound does not lose it nutrient value.

The shell, or the third layer, 16 is formed of alkaline shell material, i.e. self-hardening ashes like coal ash or hard coal ash. Other possible compounds include, without any intention of limiting the scope of the present invention to the listed alternatives, CaO or MgO, slag, alkali activated geopolymers etc. In addition to bio-boiler ashes and DIP (deinked pulp) plant ashes, applicable sources of ash are, for instance, lime sludge ash collected from the reburning kiln, green liquor ash and ash from the bark boiler. An important prerequisite for the ash to be used in fertilizer or soil conditioner production is that the heavy metal content of the ash in Finland has to be even as low as below 0,7 mg/kg bone dry (Cd) for the ash to be used as a part of an organic fertilizer in the production of organic food, and below 1, 5 mg/kg (Cd) for the ash to be used as a fertilizer in the production of fodder for livestock, or below 25 mg/kg (Cd) when used as a fertilizer in forestry. Here, cadmium has been taken as an example of heavy metals, as most often the Cd-values in the ash are, relatively speaking, the highest. The heavy metal content of the ash may be controlled by either collecting the ash from a source having no or very low share of heavy metals, or by treating the ash to get an ash fraction lean in heavy metals. On the one hand, the above given borderline values for the Cd have to be taken as an example only, as the borderline values are country-specific. On the other hand, there are countries in Central-Europe where the use of ash in fertilizers is today categorically forbidden. However, both the borderline values and the attitude towards the use of ash may change.

The alkaline shell 16 made of ash or of the above listed other options has multiple functions. Firstly, the shell material itself may act as a soil conditioner by calcificating the soil, secondly, the shell material may contain macro and micro nutrients except for such nitrogen compounds that are sensitive to the alkaline pH of the third layer, thirdly, the shell material may be provided with such additional nutrients and soil conditioners that do not react with or are not sensitive to the pH of the shell material such that its/their nutrient value is lost, fourthly, the shell material may be provided with carbon, preferably bio carbon, and fifthly, the shell material forms a hard shell 16 of the fertilizer or soil conditioner granule 10 protecting the core together with the coating 14 from breaking apart both when storing the fertilizer or soil conditioner in sacks or bags and when spreading the fertilizer or soil conditioner granules on the field.

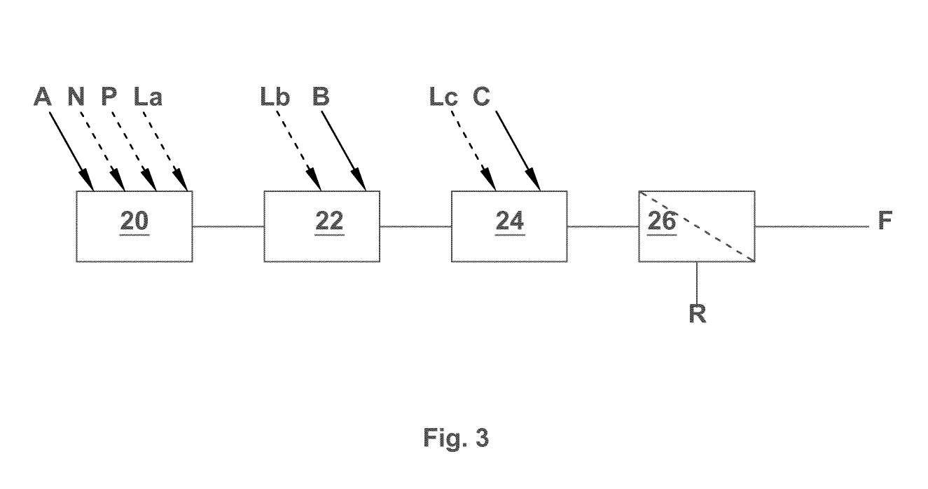

FIG. 3 discusses the method of manufacturing the fertilizer or soil conditioner granule of the preferred embodiment of the present invention. The production line comprises a first granulator 20 for producing the core, or the first layer, of the fertilizer or soil conditioner granule, a second granulator 22 for adding a coating, or second or barrier layer, on the core granule, a third granulator 24 for adding the shell, or the third layer, on the coating of the core granule, and an optional screen 26 for separating granules of unacceptable size.

The first granulator 20 for producing the core granule of the fertilizer or soil conditioner granule is a device used for producing granules from pulverous material and liquid. The first granulator may, for instance, be a table, disc or drum granulator or a pelletizer, an extruder or a coextruder, like for instance those discussed in EP-A1-0395354, U.S. Pat. No. 3,408,169, U.S. Pat. No. 6,361,720, U.S. Pat. No. 3,618,162 and EP-A2-1579766. If the first granulator 20 is a table, disc or drum granulator, it is provided with the core media A and, if the core media A is dry matter the first liquid La, which when being tumbled in the granulator form more or less spherical core granules (12, FIG. 2) the size of which grows the bigger the longer they are tumbled in the granulator. The first liquid La used in the granulation may be pure or fresh water or, preferably, such circulation liquid from an appropriate process that does not contain any compounds reactive with the inert core or coating material or with the chemicals mixed in the core media. The latter type of liquid may contain such recovered nutrient (in the following nitrogen is used as an example) compounds that may be used as a fertilizer or soil conditioner. As an example of such liquids filtrates recovered from the digestate of anaerobic digestion, from the mash from various alcohol production processes or from the bio slurry (as examples of the vast number of options listed under bio-based matter in “Definitions”) may be mentioned. Also, for instance, industrial waste waters, like filtrates of mechanical wood processing or pulp and paper mill or sugar slurries of sugar industry, etc., may be used in the granulation process for forming the core granule. The nutrients and, optionally, soil conditioner/s and/or carbon, preferably bio carbon, may also be added in dry or liquid form in the liquid upstream of the granulation by means of a heavy duty mixer.

If the core media is moist matter, for instance bio-based matter, or contains a sufficient amount of such, there is either no need for liquid La or the need is clearly smaller than in case of dry core media.

If the nitrogen compound added with the first liquid La is not sufficient for ensuring the amount of nitrogen in the fertilizer or soil conditioner to be produced or no liquid is added, nitrogen N may also be added separately or together with the core media in the granulator either in the form of liquid, powder or minor granules. A factor having an effect on the nitrogen compound to be chosen is its speed of solubility in the humidity of the soil. Also other macronutrient compounds, like for instance phosphorus (P) or potassium (K), and micronutrients like for instance selenium (Se), boron (B), and sulphur (S), that are to be added to the soil, or carbon, preferably bio carbon, may be added to the granulator either independently or together with some other material so that they are mixed in the core granule 12. Potassium and magnesium may, for instance, be added in the form of biotite. The dry substances, i.e. the core media, at least one nitrogen compound, other nutrient/s, carbon, preferably bio carbon, and/or soil conditioner/s may be, naturally, mixed, to form a certain mixture, upstream of a granulator such that the mixture is fed to the granulator separate from the rest of the dry substances.

If the first granulator 20 is a pelletizer, extruder, coextruder or the like, the core media is mixed upstream of the granulator with all such components the core granules are supposed to contain. Thus, the mixture to be granulated contains at least the core media, i.e. any one of the options or their combinations discussed earlier in this application, and the at least one nitrogen compound. Additionally, the mixture may be provided with other macro and micro nutrients as well as carbon, preferably bio carbon, and soil conditioners. Also, liquid La may be added if desired. However, if the first granulator is a coextruder the coating or barrier layer may be provided on the core, for instance, by extruding a layer of at least one of bio-based matter, kaolin, talcum, bentonite, silica, silicate, sugar slurry, polylactic acid (PLA, bio plastics and geopolymers, etc. on the core. The bio-based matter is, in a way, an advantageous barrier layer material, as its pH is of the order of 7, and its natural nitrogen content is very low. Furthermore, the bio-based layer is porous, whereby the contact between the third alkaline layer and the first layer is easily prevented.

The core granules are irrespective of the method they are produced, preferably, but not necessarily, spherical with a diameter of, preferably, but not necessarily, about 1-4 mm or cylindrical having a length of, preferably, but not necessarily, 1-4 mm and a diameter of, preferably, but not necessarily, 1-4 mm. The core granules are discharged from the first granulator 20 to a second granulator 22, which may be a table, disc or drum granulator as discussed above. The discharge of the core granules (12, FIG. 2) to the second granulator 22 may be done via an optional screening device that may be used to separate oversized and/or undersized particles from the stream of core granules. The second granulator 22 is used for providing the small core granules with pulverous inert coating material B and liquid Lb (if needed). In the second granulator 22 the core granule is moistened, if needed, with second liquid Lb and tumbled together with the inert coating material powder B (kaolin or the like discussed in more detail in connection with FIG. 2) to form the inert coating layer, or barrier layer (14, FIG. 2) on the core granule. The second liquid Lb is preferably pure or fresh water or such circulation liquid from an appropriate process that does not contain any compounds reactive with the inert coating material, with the core media or with the chemicals mixed in the core media. For instance, industrial waste waters, like filtrates of mechanical wood processing or pulp and paper mill or sugar slurries of sugar industry, etc., containing nutrients may be used in the granulation process for coating the core granule. In other words, the second liquid Lb may contain nutrients dissolved in liquid form. As an example of such liquids filtrates recovered from the digestate of anaerobic digestion, from the mash from various alcohol production processes or from the bio slurry (as examples of the vast number of options listed under bio-based matter in “Definitions”) may be mentioned. The nutrients and, optionally, soil conditioner/s and/or carbon, preferably bio carbon, may also be added in dry or liquid form either independently to the granulator or mixed with the liquid by means of a heavy duty mixer. The only prerequisite for the nutrient/s and/or soil conditioner/s to be added is that they need to withstand the moistening of the coated core granule or the possibly high pH of the shell, or the third layer, arranged, optionally, on the coating material.

Next, the coated core granule is to be further provided with another coating layer, i.e. the alkaline shell, or the alkaline third layer, 16 (FIG. 2), the coated core granules are discharged, after a predetermined time period shorter than when the core granules provided with the coating 14 (FIG. 2) are the end product, from the second granulator 22 to a third granulator 24, optionally via a screening device (not shown) that separates oversized particles from the stream of coated core granules. In the third granulator 24, which may be a table, disc or drum granulator as discussed above, the coated core granules are moistened, if needed, with third liquid Lc and tumbled with the shell material C for such a period of time that a shell 16 of desired thickness is formed on the coated core granules. The thickness of the shell 16 (FIG. 2) may be adjusted in view of the desired strength of the shell, i.e. it has to endure the stresses subjected thereto when both storing the fertilizer or soil conditioner in sacks or bags stacked one on top of another, and spreading the fertilizer or soil conditioner on the field, and/or in view of the ash (or other shell material) planned to be spread on the field. Another factor the thickness of the shell 16 has an impact on is the time it takes for the fertilizer or soil conditioner granule to be dissolved by the humidity in the soil, i.e. the thicker is the shell the longer it takes for the granule to dissolve. The material C for the shell 16 is preferably ash, i.e. self-hardening ashes like hard coal ash or ash like, for instance, lime sludge ash collected from the reburning kiln, green liquor ash and ash from the bark boiler. In place of self-hardening ash, at least one of CaO, MgO, slag, alkali activated geopolymers, burned lime and calcium carbonate may be used, as they have a similar effect on both the fertilizer granule, the soil conditioner granule and the soil. Also, sugar slurry may be used either alone or in combination with one or more of the above listed and other applicable options to harden the surface layer, i.e. the shell, of the fertilizer or soil conditioner granule.

Applicable source of the third liquid Lc is water or, preferably, such circulation liquid from an appropriate process that does not contain any compound reactive, in such a manner that reduces the nutrient value of the shell material C or the nutrient/s in the liquid Lc, with the coating material B or with the alkaline shell material C. For instance, industrial waste waters, like filtrates of mechanical wood processing, pulp and paper mill or sugar slurries of sugar industry, etc., containing nutrients may be used in the granulation process for forming the shell on the core granule. As further examples of such liquids that may be used as liquid L3 filtrates recovered from the digestate of anaerobic digestion, from the mash from various alcohol production processes or from the bio slurry (as examples of the vast number of options listed under bio-based matter in “Definitions”) may be mentioned. In other words, the third liquid Lc may contain nutrients in liquid form, but not nitrogen in a form sensitive to the pH of the alkaline layer C. The nutrients and, optionally, soil conditioner/s and/or carbon, preferably bio carbon, may also be added in dry or liquid form either independently to the granulator or mixed with the liquid by means of a heavy duty mixer. The only prerequisite for the nutrient/s and/or soil conditioner/s and/or carbon, preferably bio carbon, to be added is that they need to withstand the moistening of the fertilizer or soil conditioner granule. Preferably, the granular fertilizer or soil conditioner is produced such that the dry matter content between the core/the first layer and the shell/the third layer is evenly shared i.e. 50%/50%. However, the share of the shell may be adjusted within a wide range depending on the desired speed of solubility, i.e. the longer the nitrogen is desired to remain within the granular fertilizer or soil conditioner the higher is the share of the shell, and vice versa. Also, the more alkaline the shell is the quicker is its solubility to the acidic soil, whereby, to resist quick solubility, the shell has to be made thicker.

Thereafter, the fertilizer or soil conditioner granules are, optionally, taken to the screen 26, where oversized, and possibly also undersized, coated core granules are separated as reject R from the fertilizer or soil conditioner granules taken out as a fertilizer or soil conditioner F. The granular fertilizer or soil conditioner F is taken to be sacked or bagged, to be otherwise stored or to be sold directly. The rejected granules may be either recycled, after having been ground to applicable coarseness back to the fertilizer or soil conditioner production or packed to be sold, for instance, for manual spreading or as a growing medium.

Another option in the production of the core granule and the coated core granule is to perform the formation of the core and the coating thereof in the same granulator. In other words, the granulators 20 and 22, in case they are table, disc or drum granulators, may be replaced with a single table, disc or drum granulator whereby the following actions have to be taken. Firstly, when starting to form the coating the feed of a pH− sensitive nitrogen compound, in any form, to the granulator has to be stopped, i.e. for instance, the liquid used for forming the coating may not include such nitrogen compounds that are sensitive to the pH of the shell. However, if the nitrogen compound is not sensitive to pH, like CN, CAN or MAP their feed may be continued, if desired. Further, the feed of additional fertilizer or soil conditioner compound/s, nutrient/s and micro nutrient/s have to be considered in view of the compound to see if the compound is allowed to get into contact with atmosphere, with high pH or with ash, for instance. If the additional compound is sensitive to the surroundings, its feed has to be ceased, too.

The coextruder discussed in more detail above is another option where both the core granule and the coating thereof are performed in the same apparatus.

A further option in the production of the granular fertilizer or soil conditioner is to perform the coating of the core granule and the formation of the shell 16 in the same granulator. In other words, if, again, they are table, disc or drum granulators, the granulators 22 and 24 may be replaced with a single table, disc or drum granulator, which means that at a certain point of time, i.e. when a coating of the core granule has reached its desired thickness, the feed of coating material to the granulator is stopped, and the feed of ash or, in general, of the shell material is initiated. And a yet further option in the production of the granular fertilizer or soil conditioner is to perform all three granulation steps in the same table, disc or drum granulator, i.e. the first granulator 20, the second granulator 22 and the third granulator 24 are a single device. In such a case, the procedures taught in the earlier paragraphs have to be applied.

It has to be understood, at this stage, that the present invention is not limited to the, in a rather narrow manner exemplified, first preferred embodiment, but includes a number of other preferred embodiments and variations. Firstly, it should be noticed that already when discussing the first preferred embodiment, it was taught, referring to FIG. 2 that the core granule 12 is in broader terms a first layer, the coating 14 is a barrier layer and the alkaline shell 16 a third layer. In other words, the broader interpretation of the first embodiment encompasses the following variations: 1) the first layer may not necessarily be the innermost layer, but there may be one or more layers inside the first layer, 2) the barrier layer may not necessarily be next to (in direct communication with) the first layer, but there may be one or more layers therebetween, 3) the alkaline third layer may not necessarily be next to (in direct communication with) the barrier layer, but there may be one or more layers therebetween, 4) the order of the three layers may be the opposite, i.e. the first layer (of the three layers) being the outermost layer, the third layer the innermost layer and the barrier layer being located, again, therebetween.

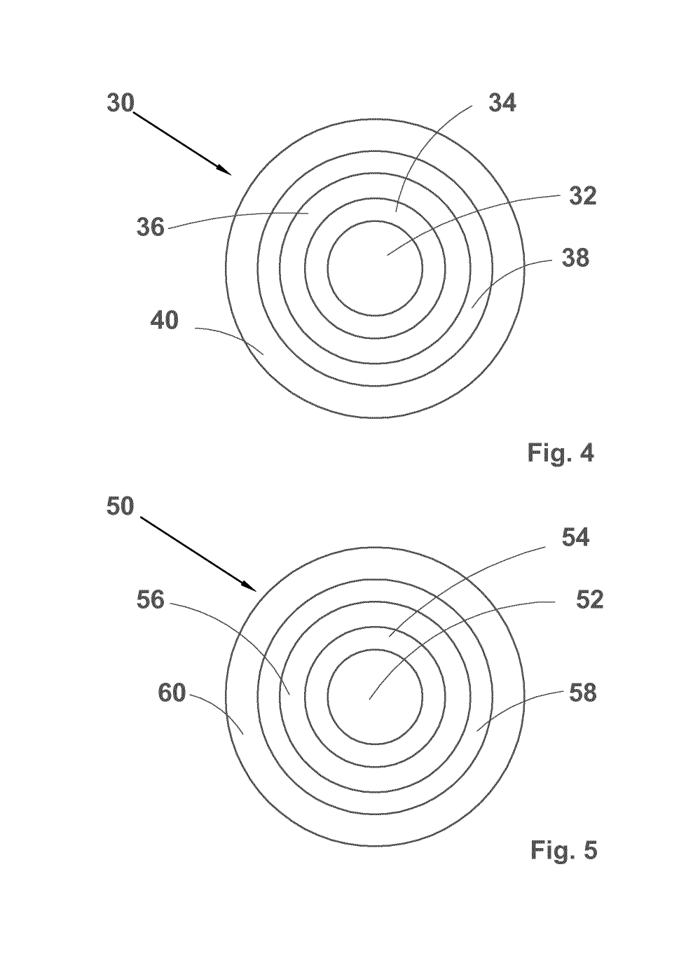

FIG. 4 illustrates schematically the granular fertilizer or soil conditioner 30 in accordance with a second preferred embodiment of the present invention. Here the fertilizer or soil conditioner granule 30 is built on top of the fertilizer or soil conditioner granule of the first preferred embodiment, such that the first three or innermost layers, i.e. the first layer 32 corresponding to the core granule 12 of FIG. 2, the second or barrier layer 34 corresponding to the coating 14, and the third layer 36 corresponding to the shell 16, are the same, whereby their detailed construction may be learned from FIG. 2 and its description. The fertilizer or soil conditioner granule 30 of FIG. 4 has an inert barrier layer 38 outside the alkaline third layer 36 such that the inert barrier layer 38 may be provided, in addition to the inert coating material, with such nutrient/s and/or soil conditioner/s and/or carbon, preferably bio carbon, that are desired to dissolve in the soil before the nutrient/s and/or soil conditioner/s and/or carbon, preferably bio carbon, provided in the inner layer/s of the granule. Naturally the nutrient/s and/or soil conditioner/s and/or carbon, preferably bio carbon, used in the fourth or inert barrier layer 38 are such that are insensitive to pH of the third layer 36. If desired, as a variation of the second preferred embodiment of the present invention, the above describer four-layer granule may well be used as a fertilizer or soil conditioner as is. However, FIG. 4 teaches that there is another alkaline layer 40 on top of the inert barrier layer 38. The alkaline layer 40 is formed of the same material/s as the inner alkaline layer 36, corresponding to the shell 16 discussed in connection with FIGS. 2 and 3. The outermost alkaline layer 40, especially when it is of ash, dissolves slowly in the acidic soil, whereby it may be arranged to carry such nutrient/s and/or soil conditioner/s and/or carbon, preferably bio carbon, that are needed by the plants soon after the spreading of the fertilizer or soil conditioner. Naturally, again the nutrient and the fertilizer have to be insensitive to alkaline pH. In other words, phosphorus and potassium are directly applicable, but the nitrogen compounds that may be used are CN (calcium nitrate), CAN (calcium ammonium nitrate) and/or MAP (magnesium ammonium phosphate).

FIG. 5 illustrates schematically the granular fertilizer or soil conditioner in accordance with a third preferred embodiment of the present invention. Here the granule 50 has been changed a lot from that shown in the other two embodiments. Now the granule has an alkaline layer 52 as the core layer separated by means of an inert barrier layer 54 from the layer 56 containing at least one pH sensitive nitrogen compound. On the layer 56 containing the nitrogen compound another inert barrier layer 58 is arranged, and on the inert barrier layer 58 another alkaline layer 60, i.e. the shell of the granule 50 is arranged. In this case the outermost alkaline layer 60 conditions the soil by means of its alkalinity, and possibly, by means of other soil conditioners arranged therein. Thereafter, i.e. after the alkaline layer 60 has dissolved, the inert barrier layer 58 introduces, if desired, further soil conditioners and/or nutrients (possibly also nitrogen insensitive to pH) and/or carbon, preferably bio carbon, to the soil before the dissolving of the actual nitrogen containing layer 56. By using this kind of a fertilizer or soil conditioner structure the soil conditioning feature is maintained as long as the granule remains undissolved.

In other words, the additional layers may be provided for adjusting the overall solubility of the granular fertilizer or soil conditioner or for arranging the layers to define the order in which the different nutrients in different layers dissolve in the soil or for arranging the layers in the order they withstand the alkaline ash layer. In other words, it could be the CN, MAP or CAN layer that is located immediately below the ash layer, as it endures high pH. Or the CN, MAP or CAN may be arranged in the ash layer itself, if they should dissolve soon after the spreading of the fertilizer of soil conditioner. Such additional layers may also be used for, and provided with matter capable of, adjusting the elasticity, the hardness and/or the dusting tendency of the fertilizer or soil conditioner granule.

The granular fertilizer or soil conditioner of the present invention may be used as a fertilizer or soil conditioner in both growing of traditional foodstuff, agricultural foodstuff for livestock and forestry, whereby the requirements set for the fertilizer reduce, naturally, when coming from growing of foodstuff towards forestry. For instance, in Finland the allowed heavy metal content in fertilizers used in growing of organic food products is below 0,7 mg/kg bone dry (Cd) for the ash to be used as a part of the organic fertilizer, and below 1,5 mg/kg (Cd) for the ash to be used as a fertilizer in the production of fodder for livestock, or below 25 mg/kg (Cd) when used as a fertilizer in forestry. Also the type of nitrogen has an effect on the type of fertilizer, as in the organic fertilizers only such nitrogen may be used that has its origin in the recycled material. Another use for the granular fertilizer of the present invention is an independent growing medium where various flowers or vegetables may be planted. And a further use of the granular fertilizer or soil conditioner of the present invention is soil conditioner, as the granule when provided with the shell of ash or carbonate or the like acts by adjusting the pH of the soil in addition to the fertilizing effect brought by the core granule with the nitrogen and macro and micro nutrients it contains.

As to the dimensioning of the fertilizer or soil conditioner granules, a starting point in their more or less industrial production is the requirement of modern spreading equipment, which are designed to work with the maximum diameter of 8 mm. Thus, the granules to be produced and aimed at machine type spreading need to be, today, of a size equal or less than 8 mm. However, in manual spreading or in the use as a growing medium the size of the granules does not play a role, whereby the production may be adjusted accordingly, i.e. either the end products of the entire production line need no screening (if all the production goes to manual spreading or for use as a growing medium) or the rejects of the screening at the end of the production may be packed for manual spreading or for use as a growing medium. The internal dimensions of the fertilizer or soil conditioner granule may vary a great deal, too. The core granule, i.e. the innermost layer of the granule may have a diameter as small as 1 mm, but it may also be up to 6-7 mm, if the maximum diameter of the granule is the 8 mm required by the spreading equipment. Naturally, if the maximum diameter of the granule has no actual limit, the core granule does not have such either. For a three-layer product shown in FIG. 2 the diameter of the core granule 12 may be 10-90% of the diameter of the end product, the alkaline third layer 16 may have a thickness of 90-10% of the of the diameter of the end product, and the inert barrier layer 14 may have a thickness of 1-95% of the of the diameter of the end product.

It is to be noted that above only a few most preferred embodiments of the present invention have been discussed. Thus, it is obvious that the invention is not restricted to the above described embodiments, but it may be applied in many different ways within the scope of the appended claims. The features of the present invention described in relation to a certain embodiment are within the basic concept of the invention, whereby they may be used in connection with another embodiment of the invention. Thereby also different features of the invention may be used in combination provided that such is desirable and the technical possibilities for that are available.

1. A granular fertilizer or soil conditioner comprising:
at least three layers including a layer having at least one nitrogen compound, an alkaline layer, and an inert barrier layer there between,
wherein the at least three layers form a granule in which a core granule or an innermost layer of the granule includes the layer with the at least one nitrogen compound which is in a form of a pH sensitive ammonium,
wherein the alkaline layer is an outermost layer of the at least three layers, and
wherein the alkaline layer comprising at least one of coal ash, hard coal ash, bio-boiler ash, DIP plant ash, lime sludge ash, green liquor ash and bark boiler ash.

2. The granular fertilizer or soil conditioner as recited in claim 1, wherein each of the at least three layers (12, 14, 16; 32, 34, 36) are next to one another in the fertilizer or soil conditioner granule.

3. The granular fertilizer or soil conditioner as recited in claim 1, wherein there is at least one further layer between the layer having the at least one nitrogen compound and the inert barrier layer.

4. The granular fertilizer or soil conditioner as recited in claim 1, wherein there is at least one further layer between the alkaline layer and the inert barrier layer.

5. The granular fertilizer or soil conditioner as recited in claim 2, further comprising another barrier layer positioned on the alkaline layer.

6. The granular fertilizer or soil conditioner as recited in claim 5, wherein another alkaline layer is on top of the another barrier layer.

7. The granular fertilizer or soil conditioner as recited in claim 1, wherein the at least one nitrogen compound is originating from one of a bio-based matter and commercial nitrogen source.

8. The granular fertilizer or soil conditioner as recited in claim 1, wherein the at least one nitrogen compound is one or more of: ammonium sulfate, ammonium nitrate, ammonium lactate, magnesium ammonium phosphate, calcium nitrate, calcium ammonium nitrate and urea.

9. The granular fertilizer or soil conditioner as recited in claim 1, wherein the nitrogen compound is recovered from a gaseous product, such as biogas, by means of stripping.

10. The granular fertilizer or soil conditioner as recited in claim 1, wherein the nitrogen compound is originating from a filtrate recovered while thickening bio slurries of domestic, agricultural, municipal and industrial waste and side flows, such as those of pulp mills, paper mills or sugar industry.

11. The granular fertilizer or soil conditioner as recited in claim 1, wherein the first layer having the at least one nitrogen compound comprises at least one or more of: kaolin, talcum, bentonite, silica, silicate, sugar slurry, polylactic acid (PLA), bio plastics, neutral or acidic geo polymers and bio-based matter.

12. The granular fertilizer or soil conditioner as recited in claim 1, wherein the inert barrier layer comprises kaolin, talcum, bentonite, silica, silicate, sugar slurry, polylactic acid (PLA), bio plastics, neutral or acidic geo polymers or any combination thereof.

13. The granular fertilizer or soil conditioner as recited in claim 1, wherein the layer having the at least one nitrogen compound comprises at least one of a macro nutrient, a micro nutrient, carbon and a soil conditioner.

14. The granular fertilizer or soil conditioner as recited in claim 1, wherein at least one of the inert barrier layer and the alkaline layer comprises at least one of a macro nutrient, a micro nutrient and a soil conditioner originating from a filtrate recovered while thickening bio slurries of domestic, agricultural, municipal and industrial waste and side flows.

15. The granular fertilizer or soil conditioner recited in claim 1 configured as a fertilizer in production of organic foodstuff.

16. The granular fertilizer or soil conditioner recited in claim 1 configured as a fertilizer in production of foodstuff.

17. The granular fertilizer or soil conditioner recited in claim 1 configured as a fertilizer in production of agricultural foodstuff for livestock.

18. The granular fertilizer or soil conditioner recited in claim 1 configured as a fertilizer in forestry.

19. The granular fertilizer or soil conditioner recited in claim 1 configured as a growing medium.

20. A granule of a fertilizer or soil conditioner comprising:
a core formed of an ammonium compound;
an inert barrier coating covering the core, and
a shell encasing the inert barrier coating and the core, wherein the shell is alkaline and formed of ash.
